(19) United States
(12) Patent Application Publication
(10) Pub. No.: US 2024/0280699 A1
(43) Pub. Date: Aug. 22, 2024

(54) VEHICLE DETECTION DEVICE, VEHICLE DETECTION SYSTEM, AND VEHICLE DETECTION METHOD

(71) Applicant: NEC Corporation, Minato-ku, Tokyo (JP)

(72) Inventor: Shingo KUBOKI, Tokyo (JP)

(73) Assignee: NEC Corporation, Minato-ku, Tokyo (JP)

(21) Appl. No.: 18/290,058

(22) PCT Filed: May 18, 2021
(86) PCT No.: PCT/JP2021/018818

§ 371 Date: Nov. 9, 2023

(51) Int. Cl. G01S 17/58; G01S 7/48; G01S 17/89

(52) U.S. Cl. CPC G01S 17/58; G01S 7/4802; G01S 17/89

(57) ABSTRACT

Provided is a vehicle detection device etc. that can detect a vehicle. A vehicle detection device comprises: at least one memory configured to store instructions; and at least one processor configured to execute the instructions to detect the motion of an object on the water and the motion of waves in the water surface surrounding the object, on the basis of laser light emitted onto the object and onto the water surface, and on the basis of reflected light corresponding to the laser light; and to detect a vehicle by determining whether the object is a vehicle or not, on the basis of the motion of the object and the motion of the waves.

### TECHNICAL FIELD

The present invention relates to a vehicle detection device and the like that detect a vehicle. In particular, the present invention relates to a vehicle detection device and the like that detect a vehicle by using light detection and ranging (LiDAR).

### BACKGROUND ART

PTL 1 discloses a technique for measuring a direction of a wave, velocity of the wave, and the like around an autonomous surface vehicle by using a laser radar mounted on the autonomous surface vehicle.

As a related art, techniques described in PTLs 2 and 3 are also known.

### CITATION LIST

### Patent Literature

PTL 1: Japanese Unexamined Patent Application Publication No. 2017-058322
PTL 2: Japanese Unexamined Patent Application Publication No. 2005-096674
PTL 3: Japanese Unexamined Patent Application Publication No. 2009-031188

### SUMMARY OF INVENTION

### Technical Problem

The technique described in PTL 1 is a technique for measuring a direction of a wave, velocity of the wave, and the like around an autonomous surface vehicle, and is not a technique for detecting another vehicle (for example, a suspicious ship) around the autonomous surface vehicle. Therefore, there is a problem that a vehicle cannot be detected by using the technique described in PTL 1.

In view of the above-described problem, an object of the present invention is to provide a vehicle detection device and the like being capable of detecting a vehicle.

### Solution to Problem

A vehicle detection device according to the present invention includes: a motion detection means for detecting a motion of an object on water and a motion of a wave on a water surface around the object, based on laser light being irradiated onto the object and the water surface, and reflected light associated to the laser light; and a vehicle detection means for detecting a vehicle by determining whether the object is the vehicle, based on the motion of the object and the motion of the wave.

A vehicle detection system according to the present invention includes: a motion detection means for detecting a motion of an object on water and a motion of a wave on a water surface around the object, based on laser light being irradiated onto the object and the water surface, and reflected light associated to the laser light; and a vehicle detection means for detecting a vehicle by determining whether the object is the vehicle, based on the motion of the object and the motion of the wave.

A vehicle detection method according to the present invention includes: by a motion detection means, detecting a motion of an object on water and a motion of a wave on a water surface around the object, based on laser light being irradiated onto the object and the water surface, and reflected light associated to the laser light; and, by a vehicle detection means, detecting a vehicle by determining whether the object is the vehicle, based on the motion of the object and the motion of the wave.

### Advantageous Effects of Invention

According to the present invention, it is possible to detect a vehicle.

### BRIEF DESCRIPTION OF DRAWINGS

FIG. 1 is a block diagram illustrating a main part of a vehicle detection system according to a first example embodiment.

FIG. 2 is a block diagram illustrating a main part of each of LiDAR devices in the vehicle detection system according to the first example embodiment.

FIG. 3 is a block diagram illustrating a main part of a vehicle detection device according to the first example embodiment.

FIG. 4 is a block diagram illustrating a main part of a motion detection unit in the vehicle detection device according to the first example embodiment.

FIG. 5 is a block diagram illustrating a hardware configuration of a main part of the vehicle detection device according to the first example embodiment.

FIG. 6 is a block diagram illustrating another hardware configuration of a main part of the vehicle detection device according to the first example embodiment.

FIG. 7 is a block diagram illustrating another hardware configuration of a main part of the vehicle detection device according to the first example embodiment.

FIG. 8 is a flowchart illustrating operation of the vehicle detection device according to the first example embodiment.

FIG. 9 is an explanatory diagram illustrating an example of a state where a water surface and an object in a target region are irradiated with laser light.

FIG. 10 is an explanatory diagram illustrating an example of a velocity vector associated to a motion of a wave and a velocity vector associated to a motion of an object.

FIG. 11 is an explanatory diagram illustrating an example of a state where a velocity vector associated to a motion of an object is decomposed into a parallel component and a vertical component with respect to a velocity vector associated to a motion of a wave.

FIG. 12 is a block diagram illustrating a main part of another vehicle detection device according to the first example embodiment.

FIG. 13 is a block diagram illustrating a main part of another vehicle detection system according to the first example embodiment.

FIG. 14 is a block diagram illustrating a main part of a vehicle detection system according to a second example embodiment.

FIG. 15 is a block diagram illustrating a main part of a vehicle detection device according to the second example embodiment.

FIG. 16 is a block diagram illustrating a main part of a motion detection unit in the vehicle detection device according to the second example embodiment.

FIG. 17 is a flowchart illustrating operation of the vehicle detection device according to the second example embodiment.

### EXAMPLE EMBODIMENT

Hereinafter, example embodiments of the present invention will be described in detail with reference to the accompanying drawings.

### First Example Embodiment

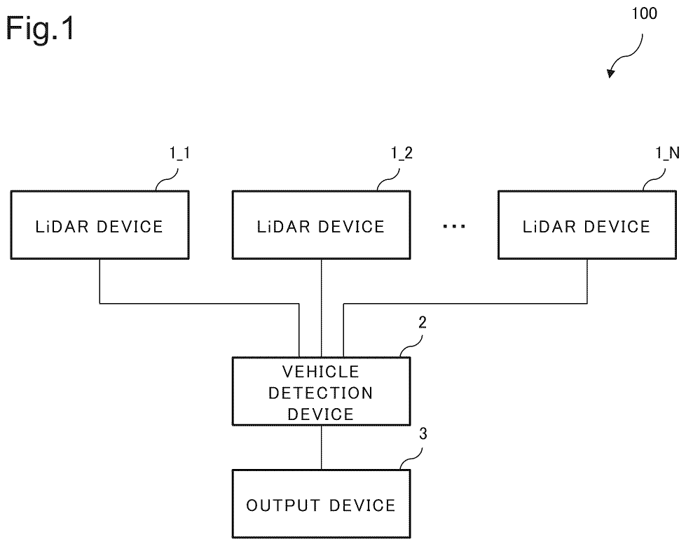

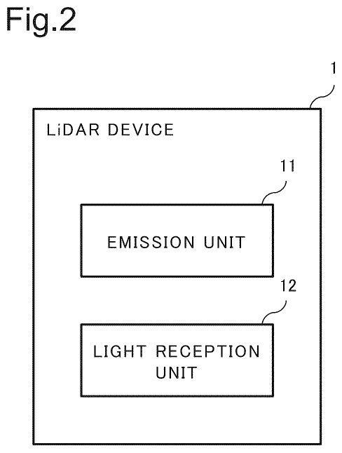

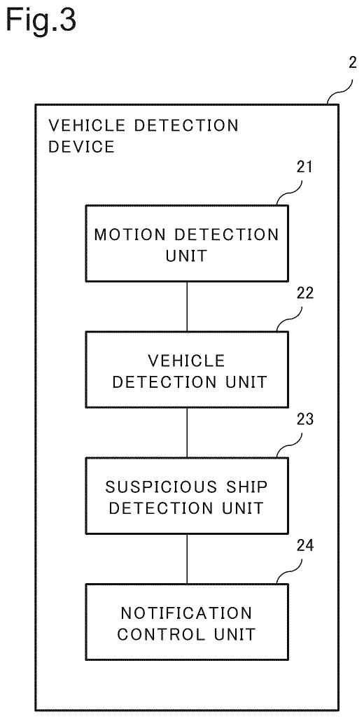

FIG. 1 is a block diagram illustrating a main part of a vehicle detection system according to a first example embodiment. FIG. 2 is a block diagram illustrating a main part of each of LiDAR devices in the vehicle detection system according to the first example embodiment. FIG. 3 is a block diagram illustrating a main part of a vehicle detection device according to the first example embodiment. Referring to FIGS. 1 to 3, the vehicle detection system according to the first example embodiment will be described.

As illustrated in FIG. 1, a vehicle detection system 100 includes N LiDAR devices 1_1 to 1_N. Herein, N is an integer of one or more. In other words, the vehicle detection system 100 includes at least one LiDAR device 1. Specifically, for example, the vehicle detection system 100 includes one, two, or three LiDAR devices 1.

Each of the LiDAR devices 1 is installed in such a way as to emit laser light toward a region (hereinafter referred to as a “target region”) A to be detected by a vehicle (for example, a ship, a personal vehicle, a rubber boat, a submarine, or the like). Herein, the vehicle is a moving body having power. Some vehicles may include a suspicious vehicle. Herein, the suspicious vehicle refers to a vehicle that should not originally be present in the target region A. In the following description, a suspicious vehicle may be referred to as a suspicious ship. Normally, the target region A is a predetermined region in a predetermined sea region. Each of the LiDAR devices 1 is installed in, for example, land around the target region A, a ship navigating around the target region A, a ship navigating inside the target region A, or an aircraft (more specifically, an airplane, a drone, or the like) flying over the target region A. The drone is an unmanned airplane capable of remote control or autonomous flight, and is also referred to as an unmanned aerial vehicle (UAV) or an unmanned aerial system (UAS).

As illustrated in FIG. 2, each of the LiDAR devices 1 includes an emission unit 11 and a light reception unit 12. The emission unit 11 emits laser light to the target region A. The emitted laser light is irradiated onto an object O on the water (e.g., on the sea) in the target region A. In addition, the emitted laser light is irradiated onto a water surface (e.g., a sea surface) in the target region A. In other words, the emitted laser light is irradiated onto the water surface (e.g., the sea surface) around the object O. The irradiated laser light is reflected as scattered light. The light reception unit 12 receives backscattered light in the reflected scattered light. Hereinafter, light received by the light reception unit 12 may be referred to as “reflected light”. In other words, reflected light received by the light reception unit 12 is associated to laser light emitted by the emission unit 11.

Note that, the object O may include a floating object on the water surface (e.g., the sea surface) in the target region A. In addition, the object O may include a vehicle that navigates in the target region A.

Herein, in each of the LiDAR devices 1, an emission direction of laser light by the emission unit 11 is variable. As a result, the emission unit 11 emits laser light in each of a plurality of directions having different directions from each other. As a result, laser light is irradiated in such a way as to scan the target region A. In other words, laser light is irradiated in such a way as to scan the target region A.

As illustrated in FIG. 1, the vehicle detection system 100 includes a vehicle detection device 2 and an output device 3. As illustrated in FIG. 3, the vehicle detection device 2 includes a motion detection unit 21, a vehicle detection unit 22, a suspicious ship detection unit 23, and a notification control unit 24.

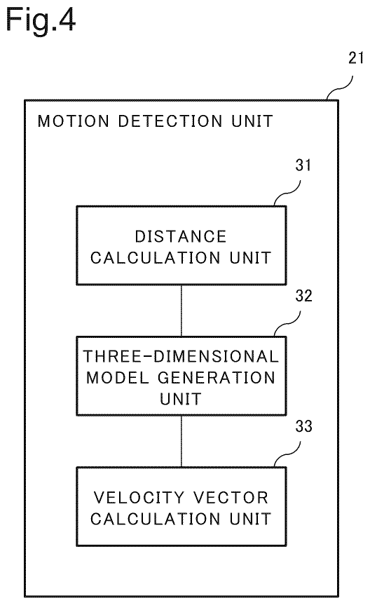

The motion detection unit 21 detects a motion of a wave W in the target region A and a motion of each of the objects O in the target region A, based on laser light emitted by each of the LiDAR devices 1 and reflected light received by each of the LiDAR devices 1. As illustrated in FIG. 4, the motion detection unit 21 includes a distance calculation unit 31, a three-dimensional model generation unit 32, and a velocity vector calculation unit 33.

In other words, the motion detection unit 21 acquires information on each of the LiDAR devices 1, information on laser light emitted by each of the LiDAR devices 1, and information on reflected light received by each of the LiDAR devices 1. Hereinafter, these pieces of information may be collectively referred to as “LiDAR information”. The LiDAR information is acquired from each of the LiDAR devices 1 by communication between the vehicle detection device 2 and each of the LIDAR devices 1.

The distance calculation unit 31 calculates a distance D between a point where each of the LiDAR devices 1 is installed and a point where laser light emitted in each direction by the corresponding LiDAR device 1 is reflected by the water surface or the object O, by using predetermined information included in the LiDAR information. Calculation of the distance D is performed by, for example, a time of flight (ToF) method or a frequency modulated continuous wave (FMCW) method.

When the ToF method is used, each of the LiDAR devices 1 emits pulse-like laser light. The LiDAR information includes information indicating timing at which laser light is emitted and information indicating timing at which reflected light is received. Alternatively, the LIDAR information includes information indicating a time difference between timing at which the laser light is emitted and timing at which the reflected light is received. The distance calculation unit 31 calculates, by using these pieces of information, the distance D by calculating a one-way propagation distance associated to a round-trip propagation time of the light.

When the FMCW method is used, each of the LiDAR devices 1 emits chirp-like laser light by performing frequency modulation on emitted laser light. Further, each of the LiDAR devices 1 generates a beat signal by performing coherent detection on received reflected light. The LiDAR information includes information indicating a frequency component included in the generated beat signal, or the like. The distance calculation unit 31 calculates, by using these pieces of information, the distance D, based on a predetermined mathematical expression related to the FMCW.

In addition, various known techniques can be used for calculation of the distance D using the LiDAR information. Description of details of these techniques will be omitted.

The three-dimensional model generation unit 32 generates a three-dimensional model M of the water surface and the object O in the target region A. For generation of the three-dimensional model M, other predetermined information included in the LiDAR information, and the distance D calculated by the distance calculation unit 31 are used.

In other words, the LiDAR information further includes information indicating a position of each of the LiDAR devices 1, and information indicating a direction in which laser light is emitted by each of the LiDAR devices 1. The three-dimensional model generation unit 32 calculates, by using these pieces of information and the calculated distance D, a position P of a point where laser light emitted in each direction by each of the LiDAR devices 1 is reflected by the water surface or the object O. The three-dimensional model generation unit 32 plots points associated to each of the positions P in a virtual three-dimensional space associated to the target region A. As a result, a three-dimensional point group model associated to a position and a shape of the water surface in at least a part of a region (more specifically, a region within a predetermined distance from any of the LiDAR devices 1) of the target region A, and a position and a shape of each of the objects O in the target region A is generated. The three-dimensional model generation unit 32 uses the generated three-dimensional point group model in the three-dimensional model M. In other words, the three-dimensional model M is constituted by a point group.

Herein, the LiDAR information further includes information indicating luminance of reflected light associated to laser light emitted in each direction by each of the LiDAR devices 1. In other words, the LIDAR information includes information indicating luminance of reflected light associated to each of the points in the three-dimensional model M. The three-dimensional model generation unit 32 compares the luminance with a predetermined threshold value, and thereby determines whether each of the points in the three-dimensional model M associates to the water surface or the object O. The three-dimensional model generation unit 32 separates the three-dimensional model M into a three-dimensional model M_1 associated to the water surface and a three-dimensional model M_2 associated to each of the objects O, by grouping a plurality of points included in the point group, based on a result of the determination. In other words, the three-dimensional model generation unit 32 generates the three-dimensional model M including the three-dimensional model M_1 associated to the water surface and the three-dimensional model M_2 associated to each of the objects O.

Normally, laser light emitted by each of the LiDAR devices 1 is obliquely incident on the water surface in the target region A. At this time, since specular reflection occurs, luminance of backscattered light is reduced. Therefore, luminance of reflected light associated to the water surface tends to be smaller than the luminance of reflected light associated to the object O. Therefore, by comparing the luminance with a threshold value, the three-dimensional models M_1 and M_2 can be separated as described above.

In addition, various known techniques can be used for generation of the three-dimensional model M using the LiDAR information and the distance D. Detailed description of these techniques will be omitted.

The velocity vector calculation unit 33 calculates a velocity vector (hereinafter, may be referred to as a “first velocity vector”) Vs indicating a motion of the wave W in the target region A, and a velocity vector (hereinafter, may be referred to as a “second velocity vector”) Vt indicating a motion of each of the objects O in the target region A. For calculation of the velocity vectors Vs and Vt, other predetermined information included in the LiDAR information, and the three-dimensional model M generated by the three-dimensional model generation unit 32 are used.

In other words, the LiDAR information further includes information indicating a frequency component included in laser light emitted in each direction by each of the LiDAR devices 1, and information indicating a frequency component included in reflected light associated to the laser light. The velocity vector calculation unit 33 calculates, by using these pieces of information, a Doppler shift amount in reflected light associated to laser light emitted in each direction by each of the LiDAR devices 1. Various known techniques according to a Doppler LiDAR can be used for calculation of the Doppler shift amount.

Further, as described above, the LiDAR information includes information indicating a direction in which laser light is emitted by each of the LiDAR devices 1. In other words, the LiDAR information includes information indicating a so-called “line-of-sight direction” for laser light associated to each of the points included in the three-dimensional model M. The velocity vector calculation unit 33 calculates, by using the information and the calculated Doppler shift amount, a vector V indicating moving velocity with respect to the line-of-sight direction associated to each of the points included in the three-dimensional model M.

The velocity vector calculation unit 33 calculates, by using the calculated vector V, the vector Vs indicating moving velocity in a virtual plane (hereinafter, referred to as a “XY plane”) associated to a horizontal plane in the target region A, for the point group constituting the three-dimensional model M_1 associated to the water surface. Specifically, for example, the velocity vector calculation unit 33 projects each of a plurality of the vectors V associated to a plurality of points included in the three-dimensional model M_1 onto the XY plane. The velocity vector calculation unit 33 calculates the vector Vs by calculating an average of the projected vectors. In this way, the velocity vector Vs is calculated.

Further, the velocity vector calculation unit 33 calculates, by using the calculated vector V, the vector Vt indicating moving velocity in the XY plane, for the point group constituting the three-dimensional model M_2 associated to each of the objects O. Specifically, for example, the velocity vector calculation unit 33 projects each of a plurality of the vectors V associated to a plurality of points included in each of the three-dimensional models M_2 onto the XY plane. The velocity vector calculation unit 33 calculates the vector Vt by calculating an average of the projected vectors. In this way, the velocity vector Vt is calculated.

Herein, each of the vectors Vt and Vs in the XY plane is a two-dimensional vector. In order to calculate such a two-dimensional vector, at least two LiDAR devices 1 installed on land or on a ship, or one LiDAR device 1 installed on an airplane are used. In other words, in this case, the vehicle detection system 100 includes at least two LiDAR devices 1 installed on land or on a ship, or one LiDAR device 1 installed on an airplane.

In contrast, the velocity vector calculation unit 33 may calculate the velocity vectors Vs and Vt in a virtual space (hereinafter, referred to as an “XYZ space”) associated to the target region A. In this case, each of the vectors Vt and Vs in the XYZ space is a three-dimensional vector. In order to calculate such a three-dimensional vector, at least three LiDAR devices 1 are used. In other words, in this case, the vehicle detection system 100 includes at least three LiDAR devices 1.

Hereinafter, an example in which the velocity vector calculation unit 33 calculates the velocity vectors Vs and Vt in the XY plane will be mainly described.

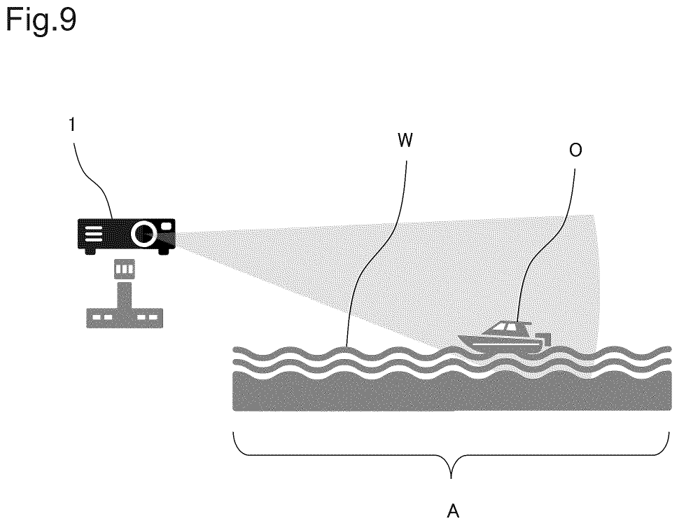

The vehicle detection unit 22 detects a vehicle in the target area A by determining whether each of the objects O in the target area A is the vehicle. The velocity vectors Vs and Vt calculated by the velocity vector calculation unit 33 are used for the determination. A specific example of a method of detecting a vehicle by the vehicle detection unit 22 will be described later with reference to FIGS. 9 to 11.

When a vehicle is detected by the vehicle detection unit 22, the suspicious ship detection unit 23 determines whether the detected vehicle is a suspicious ship.

In other words, the suspicious ship detection unit 23 acquires information indicating a position of the detected vehicle. Specifically, for example, the suspicious ship detection unit 23 converts a position of the associated three-dimensional model M_2 in the virtual three-dimensional space into latitude and longitude by using a predetermined conversion table. As a result, information indicating the position of the detected vehicle is acquired.

Further, the suspicious ship detection unit 23 acquires information indicating a motion of the detected vehicle. Specifically, for example, information indicating the associated velocity vector Vt is acquired. As a result, information indicating the motion of the detected vehicle is acquired.

Furthermore, the suspicious ship detection unit 23 acquires automatic identification system (AIS) information in the sea region associated to the target region A. The AIS information is received by a not-illustrated AIS receiver, for example. The acquired AIS information includes information indicating a position (latitude, longitude, and the like) of each of ships registered in advance. Further, the acquired AIS information includes information indicating a motion (a ground course, a ground speed, heading, turning angular velocity, and the like) of each of the ships registered in advance.

The suspicious ship detection unit 23 compares, by using these pieces of information, a position and a motion of the detected vehicle with a position and a motion of each of the ships included in the AIS information. When the position and the motion of the detected vehicle corresponds to the position and the motion of any of the ships included in the AIS information, the suspicious ship detection unit 23 determines that the detected vehicle is not a suspicious ship. Otherwise, the suspicious ship detection unit 23 determines that the detected vehicle is a suspicious ship.

When the suspicious ship is detected by the suspicious ship detection unit 23, the notification control unit 24 executes control for notifying presence of the suspicious ship. The output device 3 is used for the notification. The output device 3 includes, for example, at least one of a display device, an audio output device, and a communication device. The display device is a device using, for example, a display. The audio output device is a device using, for example, a speaker. The communication device is a device using, for example, a dedicated transmitter and receiver.

Specifically, for example, the notification control unit 24 executes control for displaying an image indicating that a suspicious ship is present. The display device of the output device 3 is used to display the image. When the image is displayed, presence of the suspicious ship is notified to a person. The image may be an image indicating a position of the suspicious ship in the target region A. For example, the image may be an image in which a point-like or icon-like image indicating the position of the suspicious ship is superimposed on a map-like or nautical chart-like image including the target region A. Alternatively, for example, the image may be displayed in the three-dimensional model M by color in which color of the three-dimensional model M_2 associated to the suspicious ship is different from color of other part.

Alternatively, for example, the notification control unit 24 executes control of outputting a sound indicating that a suspicious ship is present. The audio output device of the output device 3 is used for outputting the sound. When the sound is output, presence of the suspicious ship is notified to a person.

Alternatively, for example, the notification control unit 24 executes control of transmitting a signal indicating that a suspicious ship is present. The communication device of the output device 3 is used for transmitting the signal. When the signal is transmitted, presence of the suspicious ship is left in another system (not illustrated). The signal is transmitted to, for example, a system that monitors the sea region associated to the target region A.

In this way, the main part of the vehicle detection system 100 is configured.

Hereinafter, the emission unit 11 may be referred to as an “emission means”. The light reception unit 12 may be referred to as a “light reception means”. The motion detection unit 21 may be referred to as a “motion detection means”. The vehicle detection unit 22 may be referred to as a “vehicle detection means”. The suspicious ship detection unit 23 may be referred to as a “suspicious ship detection means”. The notification control unit 24 may be referred to as a “notification control means”.

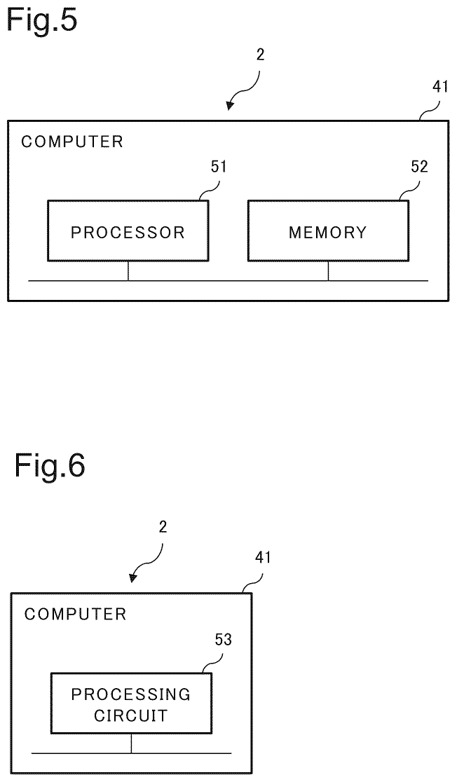

Next, with reference to FIGS. 5 to 7, a hardware configuration of a main part of the vehicle detection device 2 will be described.

As illustrated in FIGS. 5 to 7, the vehicle detection device 2 uses a computer 41.

As illustrated in FIG. 5, the computer 41 includes a processor 51 and a memory 52. The memory 52 stores a program for causing the computer 41 to function as the motion detection unit 21, the vehicle detection unit 22, the suspicious ship detection unit 23, and the notification control unit 24. The processor 51 reads and executes the program stored in the memory 52. As a result, a function F1 of the motion detection unit 21, a function F2 of the vehicle detection unit 22, a function F3 of the suspicious ship detection unit 23, and a function F4 of the notification control unit 24 are achieved.

Alternatively, as illustrated in FIG. 6, the computer 41 includes a processing circuit 53. The processing circuit 53 executes processing for causing the computer 41 to function as the motion detection unit 21, the vehicle detection unit 22, the suspicious ship detection unit 23, and the notification control unit 24. As a result, the functions F1 to F4 are achieved.

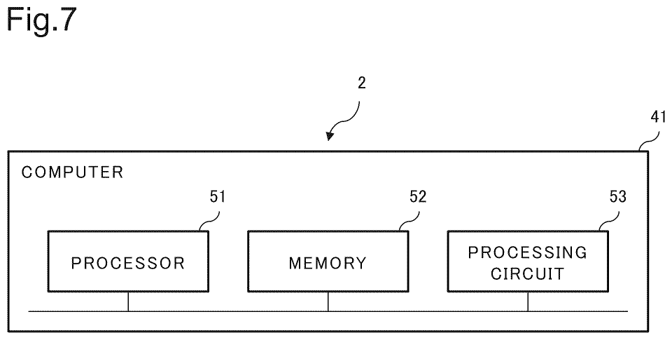

Alternatively, as illustrated in FIG. 7, the computer 41 includes a processor 51, a memory 52, and a processing circuit 53. In this case, some functions of the functions F1 to F4 are achieved by the processor 51 and the memory 52, and also the remaining functions of the functions F1 to F4 are achieved by the processing circuit 53.

The processor 51 includes one or more processors. Each of the processors is a processor using, for example, a central processing unit (CPU), a graphics processing unit (GPU), a microprocessor, a micro-controller, or a digital signal processor (DSP).

The memory 52 includes one or more memories. Each of the memories is a memory using, for example, a random access memory (RAM), a read only memory (ROM), a flash memory, an erasable programmable read only memory (EPROM), an electrically erasable programmable read only memory (EEPROM), a solid state drive, a hard disk drive, a flexible disk, a compact disc, a digital versatile disc (DVD), a Blu-ray disc, a magneto optical (MO) disk, or mini disc.

The processing circuit 53 includes one or more processing circuits. Each of the processing circuits is a processing circuit using, for example, an application specific integrated circuit (ASIC), a programmable logic device (PLD), a field programmable gate array (FPGA), a system on a chip (SoC), or a system large scale integration (LSI).

The processor 51 may include a dedicated processor associated to each of the functions F1 to F4. The memory 52 may include a dedicated memory associated to each of the functions F1 to F4. The processing circuit 53 may include a dedicated processing circuit associated to each of the functions F1 to F4.

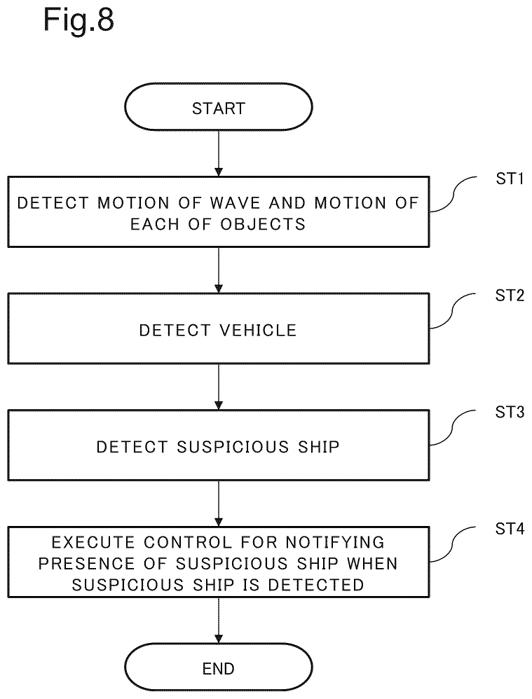

Next, operation of the vehicle detection device 2 will be described with reference to a flowchart illustrated in FIG. 8.

First, the motion detection unit 21 detects a motion of the wave W in the target region A, and also detects a motion of each of the objects O in the target region A (step ST1). Details of a method of detecting a motion by the motion detection unit 21 are as described above. Therefore, description thereof again will be omitted.

Subsequently, the vehicle detection unit 22 detects a vehicle in the target region A by determining whether each of the objects O is the vehicle (step ST2). Details of a method of detecting a vehicle by the vehicle detection unit 22 will be described later with reference to FIGS. 9 to 11.

Subsequently, when the vehicle is detected in step ST2, the suspicious ship detection unit 23 detects a suspicious ship in the target region A by determining whether the detected vehicle is the suspicious ship (step ST3). Details of a method of detecting a suspicious ship by the suspicious ship detection unit 23 are as described above. Therefore, description thereof again will be omitted.

Subsequently, when the suspicious ship is detected in step ST3, the notification control unit 24 executes control for notifying presence of the suspicious ship (step ST4). Details of the notification are as described above. Therefore, description thereof again will be omitted.

When a vehicle is not detected in step ST2, the processing of steps ST3 and ST4 is skipped. In addition, when a suspicious ship is not detected in step ST3, the processing of step ST4 is skipped.

Next, with reference to FIGS. 9 to 11, details of a method of detecting a vehicle by the vehicle detection unit 22 will be described.

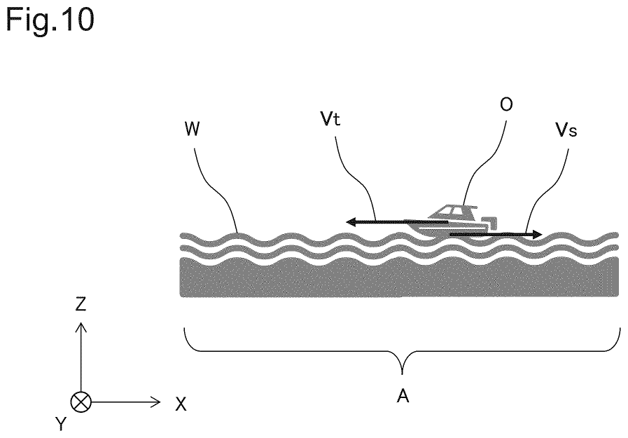

FIG. 9 illustrates an example of a state where the water surface and the object O of the target region A are irradiated with laser light when one object O is present in the target region A. In the example illustrated in FIG. 9, the object O is a vehicle (more specifically, a ship). FIG. 10 illustrates an example of the velocity vectors Vs and Vt calculated by the velocity vector calculation unit 33 in the state illustrated in FIG. 9. Each of the velocity vectors Vs and Vt is a two-dimensional vector in the XY plane. The velocity vector Vs associates to a motion of the wave W. The velocity vector Vt associates to a motion of the object O.

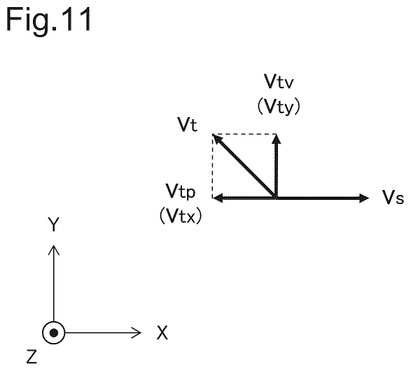

The vehicle detection unit 22 calculates a parallel component Vtp with respect to the velocity vector Vs in the velocity vector Vt. Further, the vehicle detection unit 22 calculates a vertical component Vtv with respect to the velocity vector Vs in the velocity vector Vt. In other words, the vehicle detection unit 22 separates the velocity vector Vt into the parallel component Vtp and the vertical component Vtv with respect to the velocity vector Vs. FIG. 11 illustrates an example of the separated parallel component Vtp and the separated vertical component Vtv.

At this time, the vehicle detection unit 22 sets an X-axis in the XY plane as an axis parallel to the velocity vector Vs. Therefore, the parallel component Vtp is an X component Vtx of the velocity vector Vt. The vertical component Vtv is a Y component Vty of the velocity vector Vt.

### <First Determination Method>

The vehicle detection unit 22 calculates a relative velocity vector Vrp indicating a difference between the parallel component Vtp and the velocity vector Vs by the following equation (1).

$$Vrp = Vtp - V s \qquad ( 1 )$$

Subsequently, the vehicle detection unit 22 compares a magnitude |Vrp| of the relative velocity vector Vrp with a predetermined threshold value Th1. When a condition (hereinafter referred to as a “first condition”) indicated by the following expression (2) is satisfied, the vehicle detection unit 22 determines that the object O is a vehicle. On the other hand, when the first condition is not satisfied, the vehicle detection unit 22 determines that the object O is not a vehicle.

$$\vert Vrp \vert > Th 1 \qquad ( 2 )$$

In other words, the magnitude |Vrp| of the relative velocity vector Vrp corresponds to an amount of deviation of a motion of the object O with respect to a motion of the wave W in an X direction. When the amount of deviation is large, the object O is highly likely to move against a wave in the target region A. In this case, it is considered that the object O is highly likely to be a moving body having power, that is, a vehicle. On the other hand, when the amount of deviation is small, it is considered that the object O is highly likely to be an object flowing in a wave in the target region A, that is, a floating object. Therefore, the vehicle detection unit 22 determines whether the object O is a vehicle by threshold value determination using |Vrp| as described above.

### <Second Determination Method>

The vehicle detection unit 22 compares a magnitude |Vtv| of the vertical component Vtv with a predetermined threshold value Th2. When a condition (hereinafter referred to as a “second condition”) indicated by the following expression (3) is satisfied, the vehicle detection unit 22 determines that the object O is a vehicle. On the other hand, when the second condition is not satisfied, the vehicle detection unit 22 determines that the object O is not a vehicle.

$$\vert Vtv \vert > Th 2 \qquad ( 3 )$$

In other words, the magnitude |Vtv| of the vertical component Vtv corresponds to an amount of deviation of a motion pattern of the object O with respect to a motion of the wave W in a Y direction. When the amount of deviation is large, it is considered that the object O is highly likely to be a moving body having power, that is, a vehicle. On the other hand, when the amount of deviation is small, it is considered that the object O is highly likely to be an object flowing in a wave in the target region A, that is, a floating object. Therefore, the vehicle detection unit 22 determines whether the object O is a vehicle by threshold value determination using |Vtv| as described above.

### <Third Determination Method>

The vehicle detection unit 22 calculates the relative velocity vector Vrp by the above equation (1).

Subsequently, the vehicle detection unit 22 compares the magnitude |Vrp| of the relative velocity vector Vrp with the threshold value Th1, and also compares the magnitude |Vtv| of the vertical component Vtv with the threshold value Th2. When at least one of the first condition and the second condition is satisfied, the vehicle detection unit 22 determines that the object O is a vehicle. On the other hand, when the first condition is not satisfied and also the second condition is not satisfied, the vehicle detection unit 22 determines that the object O is not a vehicle.

As described above, by using both the relative velocity vector Vrp and the vertical component Vtv, it is possible to improve accuracy of determination of whether the object O is a vehicle. In particular, when the object O is a vehicle, it is possible to suppress occurrence of erroneous determination that the object O is not a vehicle.

### <Fourth Determination Method>

The vehicle detection unit 22 calculates the relative velocity vector Vrp by the above equation (1).

Subsequently, the vehicle detection unit 22 calculates an integrated value ∫(|Vrp|)(dt) for a predetermined time period with respect to the magnitude |Vrp| of the relative velocity vector Vrp. The vehicle detection unit 22 compares the integrated value ∫(|Vrp|)(dt) with a predetermined threshold value Th3. When a condition (hereinafter referred to as a “third condition”) indicated by the following expression (4) is satisfied, the vehicle detection unit 22 determines that the object O is a vehicle. On the other hand, when the third condition is not satisfied, the vehicle detection unit 22 determines that the object O is not a vehicle.

$$\int ( \vert Vrp \vert ) ( dt ) > Th 3 \qquad ( 4 )$$

As described above, by using the integrated value ∫(|Vrp|)(dt) for the predetermined time period, it is possible to suppress occurrence of erroneous discrimination due to time variation of | Vrp|, as compared with a case where |Vrp| at a specific time point is used.

### <Fifth Determination Method>

The vehicle detection unit 22 calculates an integrated value ∫(|Vtv|)(dt) for a predetermined time period with respect to the magnitude |Vtv| of the vertical component Vtv. The vehicle detection unit 22 compares the integrated value (|Vtv|)(dt) with a predetermined threshold value Th4. When a condition (hereinafter referred to as the a “fourth condition”) indicated by the following expression (5) is satisfied, the vehicle detection unit 22 determines that the object O is a vehicle. On the other hand, when the fourth condition is not satisfied, the vehicle detection unit 22 determines that the object O is not a vehicle.

$$\int ( \vert Vtv \vert ) ( dt ) > Th 4 \qquad ( 5 )$$

As described above, by using the integrated value ∫(|Vtv|)(dt) for the predetermined time period, it is possible to suppress occurrence of erroneous discrimination due to time variation of |Vtv|, as compared with a case where |Vtv| at a specific time point is used.

### <Sixth Determination Method>

The vehicle detection unit 22 calculates the relative velocity vector Vrp by the above equation (1).

Subsequently, the vehicle detection unit 22 calculates the integrated value ∫(|Vrp|)(dt) for a predetermined time period with respect to the magnitude |Vrp| of the relative velocity vector Vrp. In addition, the vehicle detection unit 22 calculates the integrated value ∫(|Vtv|)(dt) for a predetermined time period with respect to the magnitude |Vtv| of the vertical component Vtv.

The vehicle detection unit 22 compares the integrated value ∫(|Vrp|)(dt) with the threshold value Th3, and also compares the integrated value ∫(|Vtv|)(dt) with the threshold value Th4. When at least one of the third condition and the fourth condition is satisfied, the vehicle detection unit 22 determines that the object O is a vehicle. On the other hand, when the third condition is not satisfied and also the fourth condition is not satisfied, the vehicle detection unit 22 determines that the object O is not a vehicle.

As described above, by using both the relative velocity vector Vrp and the vertical component Vtv, it is possible to improve accuracy of determination of whether the object O is a vehicle. Further, by using the integrated value ∫(|Vrp|)(dt) for a predetermined time period, it is possible to suppress occurrence of erroneous determination due to time variation of |Vrp|, as compared with a case where |Vrp| at a specific time point is used. Further, by using the integrated value ∫(|Vtv|)(dt) for a predetermined time period, it is possible to suppress occurrence of erroneous determination due to time variation of |Vtv|, as compared with a case where |Vtv| at a specific time point is used.

Next, a modification example of the vehicle detection system 100 will be described.

The method of detecting a suspicious ship by the suspicious ship detection unit 23 is not limited to the above-described specific example (i.e., an example using AIS information). For example, the suspicious ship detection unit 23 may use the following method in determining whether a vehicle detected by the vehicle detection unit 22 is a suspicious ship.

In other words, the suspicious ship detection unit 23 stores in advance information indicating one or more patterns of a position and a motion of a suspicious ship detected in a past in the sea region associated to the target region A. The suspicious ship detection unit 23 compares a position and a motion of the vehicle detected by the vehicle detection unit 22 with each of the patterns. In other words, the suspicious ship detection unit 23 compares a position and a motion of the vehicle detected by the vehicle detection unit 22 with a predetermined pattern being set in advance. When the position and the motion of the vehicle detected by the vehicle detection unit 22 is equivalent to any pattern, the suspicious ship detection unit 23 determines that the detected vehicle is a suspicious ship. Otherwise, the suspicious ship detection unit 23 determines that the detected vehicle is not a suspicious ship.

Next, another modification example of the vehicle detection system 100 will be described.

Each of the LiDAR devices 1 may be installed in the water (e.g., in the sea) around the target region A, or in the water (e.g., in the sea) inside the target region A. In other words, each of the LiDAR devices 1 may be formed by using an underwater LiDAR. In this case, laser light is emitted by the emission unit 11 provided in the water, and reflected light is received by the light reception unit 12 provided in the water. At this time, a frequency of the emitted laser light is preferably set to a frequency for the underwater LiDAR.

Next, an advantageous effect using the vehicle detection system 100 will be described.

As described above, in the vehicle detection device 2, the motion detection unit 21 detects a motion of the object O on water and a motion of the wave W on the water surface around the object O, based on laser light being irradiated onto the object O and the water surface, and reflected light associated to the laser light. The vehicle detection unit 22 detects a vehicle by determining whether the object O is the vehicle, based on the motion of the object O and the motion of the wave W. As a result, it is possible to detect a vehicle in the target region A.

In particular, by using the LiDAR device 1, it is possible to detect a vehicle regardless of ambient brightness, as compared with a case where a visible light camera is used. In addition, normally, a distance at which the object O can be detected by using the LiDAR device 1 is longer than a distance at which the object O can be detected by the visible light camera. Therefore, when the target region A is particularly wide, the number of installed devices can be reduced, as compared with the case where the visible light camera is used. Further, by using the LiDAR device 1, it is possible to reduce a personnel cost, as compared with a case where a manned ship performs a patrol in order to detect a vehicle (in particular, a suspicious ship).

Further, the motion detection unit 21 detects a motion of the object O and a motion of the wave W, based on a Doppler shift amount of reflected light. As a result, it is possible to detect a motion of the object O and a motion of the wave W by using a technique related to a Doppler LiDAR.

Further, the vehicle detection unit 22 determines whether the object O is a vehicle, based on an amount of deviation of a motion of the object O with respect to a motion of the wave W, by using the first velocity vector Vs indicating the motion of the wave W and the second velocity vector Vt indicating the motion of the object O. By using the velocity vectors Vs and Vt, it is possible to determine whether the object O is a vehicle, for example, based on the method described with reference to FIGS. 9 to 11.

Further, when it is determined that the object O is a vehicle, the suspicious ship detection unit 23 detects a suspicious ship by determining whether the vehicle is the suspicious ship. As a result, it is possible to detect a suspicious ship in the target region A.

Further, the suspicious ship detection unit 23 acquires AIS information, compares a position and a motion of a vehicle with a position and a motion of each of ships included in the AIS information, and thereby determines whether the vehicle is a suspicious ship. By using the AIS information, it is possible to determine whether a vehicle is a suspicious ship, as described above.

Further, the suspicious ship detection unit 23 determines whether a vehicle is a suspicious ship by comparing a motion of the vehicle with a motion pattern being set in advance. By using the pattern, it is possible to determine whether a vehicle is a suspicious ship, as described above. In particular, even in a case where the AIS information cannot be acquired, it is possible to determine whether a vehicle is a suspicious ship.

Further, when it is determined that a vehicle is a suspicious ship, the notification control unit 24 executes control for notifying presence of the suspicious ship. As a result, it is possible to notify a person or another system of presence of a suspicious ship in the target region A.

Further, laser light is emitted by the emission unit 11 provided in the water, and reflected light is received by the light reception unit 12 provided in the water. As result, in detecting a vehicle, an underwater LIDAR can be used.

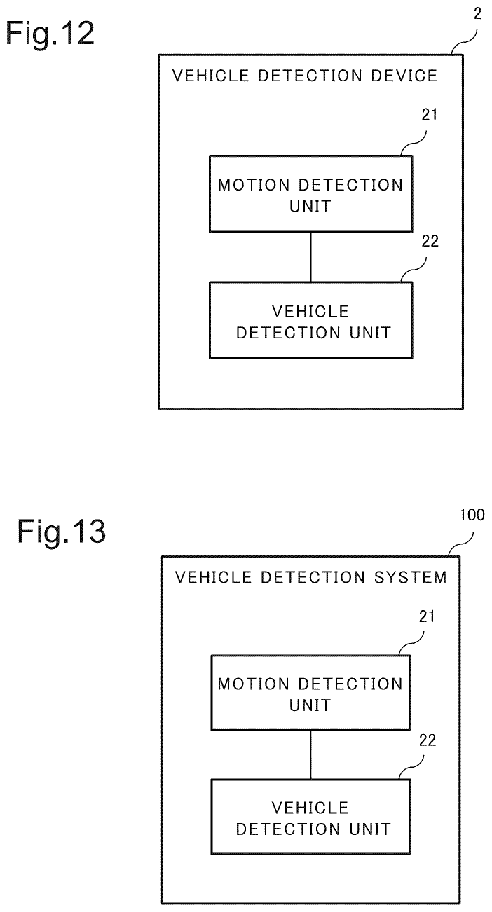

Next, a modification example of the vehicle detection device 2 will be described with reference to FIG. 12. Another modification example of the vehicle detection system 100 will be described with reference to FIG. 13.

As illustrated in FIG. 12, the vehicle detection device 2 may include the motion detection unit 21 and the vehicle detection unit 22. In other words, the motion detection unit 21 and the vehicle detection unit 22 may constitute a main part of the vehicle detection device 2. In this case, the suspicious ship detection unit 23 and the notification control unit 24 may be provided outside the vehicle detection device 2. In other words, it can be said that one specific example of the vehicle detection device 2 illustrated in FIG. 12 is the vehicle detection device 2 illustrated in FIG. 3.

As illustrated in FIG. 13, the vehicle detection system 100 may include the motion detection unit 21 and the vehicle detection unit 22. In other words, the motion detection unit 21 and the vehicle detection unit 22 may constitute a main part of the vehicle detection system 100. In this case, the suspicious ship detection unit 23 and the notification control unit 24 may be provided outside the vehicle detection system 100. In addition, the LiDAR devices 1_1 to 1_N and the output device 3 may be provided outside the vehicle detection system 100. In other words, it can be said that one specific example of the vehicle detection system 100 illustrated in FIG. 13 is the vehicle detection system 100 illustrated in FIG. 1.

Even in these cases, the above-described advantageous effect can be acquired. In other words, the motion detection unit 21 detects a motion of the object O on water and a motion of the wave W on the water surface around the object O, based on laser light being irradiated onto the object O and the water surface, and reflected light associated to the laser light. The vehicle detection unit 22 detects a vehicle by determining whether the object O is the vehicle, based on the motion of the object O and the motion of the wave W. As a result, it is possible to detect a vehicle.

The vehicle detection system 100 may include the suspicious ship detection unit 23, in addition to the motion detection unit 21 and the vehicle detection unit 22. The vehicle detection system 100 may further include the notification control unit 24. Each unit of the vehicle detection system 100 may be constituted by an independent device. These devices may be distributed geographically or in a networked manner. For example, these devices may include an edge computer and a cloud computer.

### Second Example Embodiment

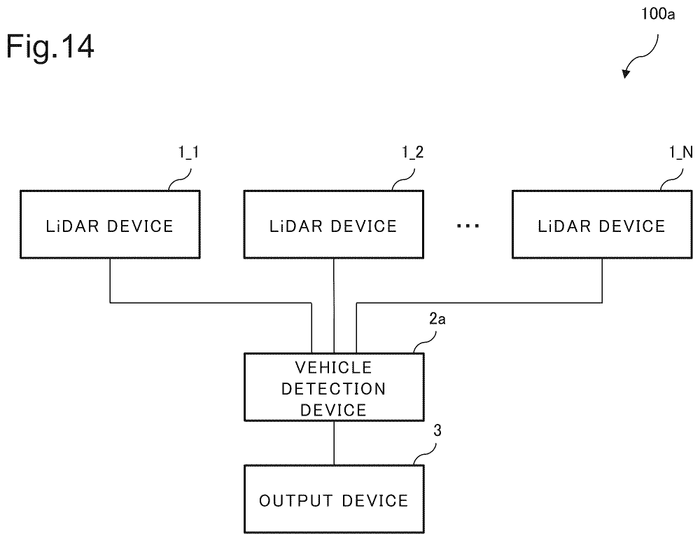

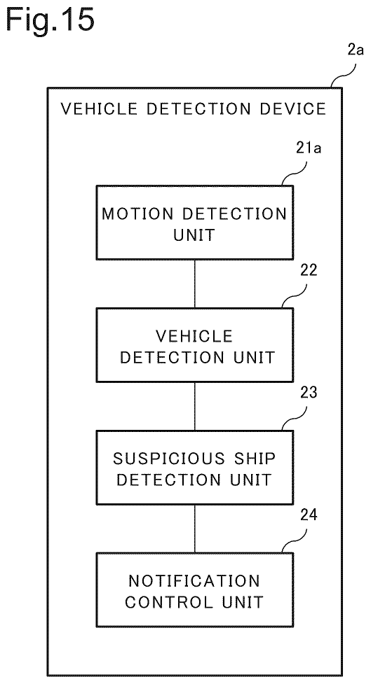

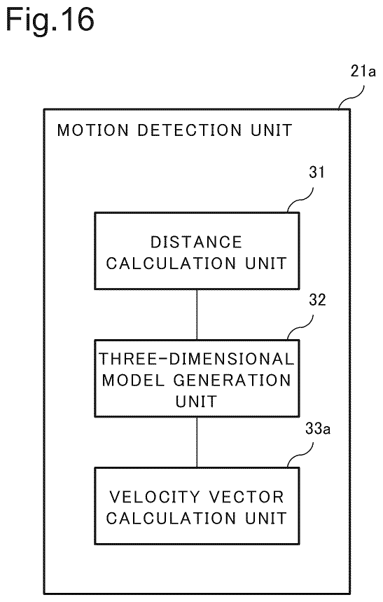

FIG. 14 is a block diagram illustrating a main part of a vehicle detection system according to a second example embodiment. FIG. 15 is a block diagram illustrating a main part of a vehicle detection device according to the second example embodiment. FIG. 16 is a block diagram illustrating a main part of a motion detection unit in the vehicle detection device according to the second example embodiment. Referring to FIGS. 14 to 16, the vehicle detection system according to the second example embodiment will be described. In FIGS. 14 to 16, a similar block to that illustrated in FIGS. 1, 3, and 4 is denoted by a similar reference sign, and description thereof will be omitted.

As illustrated in FIG. 14, a vehicle detection system 100a includes LiDAR devices 1_1 to 1_N, a vehicle detection device 2a, and an output device 3. As illustrated in FIG. 15, the vehicle detection device 2a includes a motion detection unit 21a, a vehicle detection unit 22, a suspicious ship detection unit 23, and a notification control unit 24. As illustrated in FIG. 16, the motion detection unit 21a includes a distance calculation unit 31, a three-dimensional model generation unit 32, and a velocity vector calculation unit 33a. Hereinafter, the motion detection unit 21a may be referred to as a “motion detection means”.

The velocity vector calculation unit 33 in the vehicle detection device 2 according to the first example embodiment calculates velocity vectors Vt and Vs, based on a Doppler shift amount in reflected light received by each of the LiDAR devices 1. In contrast, the velocity vector calculation unit 33a calculates the velocity vectors Vt and Vs, based on time change of a three-dimensional model M.

In other words, scanning of a target region A by each of the LiDAR devices 1 is performed at a predetermined time interval. As a result, the three-dimensional model M is generated at the predetermined time interval. In other words, a plurality of three-dimensional models M associated to a plurality of consecutive time points are generated. The three-dimensional model M associated to each time point may include a three-dimensional model M_1 associated to a water surface, and also include a three-dimensional model M_2 associated to each of objects O.

The velocity vector calculation unit 33a detects, for the three-dimensional model M_1 associated to each time point, a position of a portion associated to each of waves of a wave W (or a portion associated to at least one selected wave of the wave W). The velocity vector calculation unit 33a calculates the velocity vector Vs indicating a motion of the wave W, based on time change of the detected position. In a case where the time change of the detected position is different for each wave, the velocity vector Vs may be calculated based on an average thereof.

Further, the velocity vector calculation unit 33a detects, for the three-dimensional model M associated to each time, a position of the three-dimensional model M_2 associated to each of the objects O. The velocity vector calculation unit 33a calculates the velocity vector Vt indicating a motion of each of the objects O, based on time change of the detected position.

In this way, a motion of the wave W in the target region A is detected, and a motion of each of the objects O in the target region A is detected.

A hardware configuration of a main part of the vehicle detection device 2a is similar to that described with reference to FIGS. 5 to 7 in the first example embodiment. Therefore, a detailed description thereof will be omitted. In other words, the vehicle detection device 2a has a function Fla of the motion detection unit 21a, a function F2 of the vehicle detection unit 22, a function F3 of the suspicious ship detection unit 23, and a function F4 of the notification control unit 24. Each of the functions Fla, F2, F3, and F4 may be achieved by a processor 51 and a memory 52, or may be achieved by a processing circuit 53.

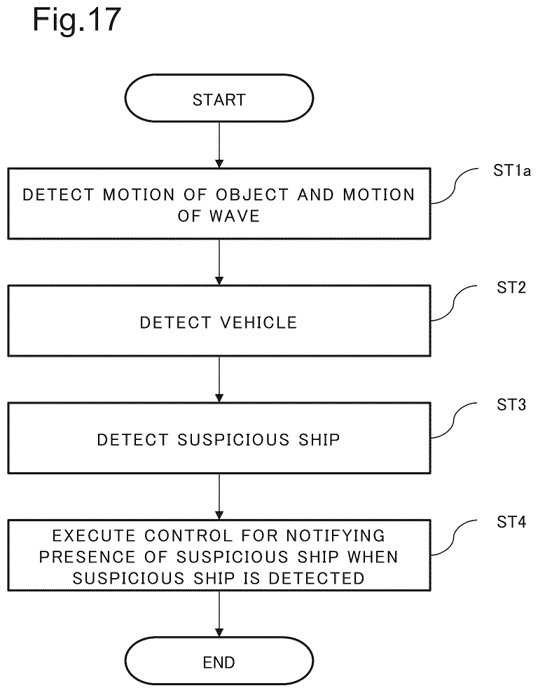

Next, operation of the vehicle detection device 2a will be described with reference to a flowchart illustrated in FIG. 17. In FIG. 17, a similar step to that illustrated in FIG. 8 is denoted by the same reference sign, and the description thereof is omitted.

First, the motion detection unit 21a detects a motion of the wave W in the target region A, and also detects a motion of each of the objects O in the target region A (step ST1a). Details of a method of detecting a motion by the motion detection unit 21a are as described above. Therefore, description thereof again will be omitted. Subsequently, processing of steps ST2 to ST4 are sequentially executed.

Next, an advantageous effect using the vehicle detection system 100a will be described.

The vehicle detection system 100a has a similar advantageous effect to that of the vehicle detection system 100 according to the first example embodiment. In other words, by using the vehicle detection system 100a, it is possible to detect a vehicle in the target region A. Further, by determining whether the detected vehicle is a suspicious ship, it is possible to detect a suspicious ship in the target region A.

Next, a modification example of the vehicle detection device 2a will be described. Further, a modification example of the vehicle detection system 100a will be described.

Various modification examples similar to those described in the first example embodiment can be adopted for the vehicle detection device 2a. For example, similarly to the example described with reference to FIG. 12, the motion detection unit 21a and the vehicle detection unit 22 may constitute the main part of the vehicle detection device 2a.

Various modification examples similar to those described in the first example embodiment can be adopted for the vehicle detection system 100a. For example, similarly to the example described with reference to FIG. 13, the motion detection unit 21a and the vehicle detection unit 22 may constitute a main part of the vehicle detection system 100a. In addition, the vehicle detection system 100a may include the suspicious ship detection unit 23. The vehicle detection system 100a may further include the notification control unit 24.

Although the present invention has been described with reference to the example embodiments, the present invention is not limited to the above example embodiments. Various modifications that can be understood by a person skilled in the art within the scope of the present invention can be made to the configuration and details of the present invention.

Some or all of the above-described example embodiments may be described as the following supplementary notes, but are not limited thereto.

### [Supplementary Notes]

### [Supplementary Note 1]

A vehicle detection device including:
a motion detection means for detecting a motion of an object on water and a motion of a wave on a water surface around the object, based on laser light being irradiated onto the object and the water surface, and reflected light associated to the laser light; and
a vehicle detection means for detecting a vehicle by determining whether the object is the vehicle, based on the motion of the object and the motion of the wave.

### [Supplementary Note 2]

The vehicle detection device according to supplementary note 1, wherein
the motion detection means detects a motion of the object and a motion of the wave, based on a Doppler shift amount of the reflected light.

### [Supplementary Note 3]

The vehicle detection device according to supplementary note 1, wherein
the motion detection means generates a three-dimensional model of the object and the water surface, based on the reflected light, and detects a motion of the object and a motion of the wave, based on time change of the three-dimensional model.

### [Supplementary Note 4]

The vehicle detection device according to any one of supplementary notes 1 to 3, wherein
the vehicle detection means determines whether the object is the vehicle, based on an amount of deviation of a motion of the object with respect to a motion of the wave, by using a first velocity vector indicating the motion of the wave and a second velocity vector indicating the motion of the object.

### [Supplementary Note 5]

The vehicle detection device according to any one of supplementary notes 1 to 4, further including
a suspicious ship detection means for detecting a suspicious ship by determining whether the vehicle is the suspicious ship when it is determined that the object is the vehicle.

### [Supplementary Note 6]

The vehicle detection device according to supplementary note 5, wherein
the suspicious ship detection means acquires AIS information, compares a position and a motion of the vehicle with a position and a motion of each of ships included in the AIS information, and thereby determines whether the vehicle is the suspicious ship.

### [Supplementary Note 7]

The vehicle detection device according to supplementary note 5, wherein
the suspicious ship detection means determines whether the vehicle is the suspicious ship by comparing a motion of the vehicle with a motion pattern being set in advance.

### [Supplementary Note 8]

The vehicle detection device according to any one of supplementary notes 5 to 7, wherein
presence of the suspicious ship is notified when it is determined that the vehicle is the suspicious ship.

### [Supplementary Note 9]

The vehicle detection device according to any one of supplementary notes 1 to 8, wherein
the laser light is emitted by an emission means provided in water, and
the reflected light is received by a light reception means provided in water.

### [Supplementary Note 10]

A vehicle detection system including:
a motion detection means for detecting a motion of an object on water and a motion of a wave on a water surface around the object, based on laser light being irradiated onto the object and the water surface, and reflected light associated to the laser light; and
a vehicle detection means for detecting a vehicle by determining whether the object is the vehicle, based on the motion of the object and the motion of the wave.

### [Supplementary Note 11]

The vehicle detection system according to supplementary note 10, wherein
the motion detection means detects a motion of the object and a motion of the wave, based on a Doppler shift amount of the reflected light.

### [Supplementary Note 12]

The vehicle detection system according to supplementary note 10, wherein
the motion detection means generates a three-dimensional model of the object and the water surface, based on the reflected light, and detects a motion of the object and a motion of the wave, based on time change of the three-dimensional model.

### [Supplementary Note 13]

The vehicle detection system according to any one of supplementary notes 10 to 12, wherein
the vehicle detection means determines whether the object is the vehicle, based on an amount of deviation of a motion of the object with respect to a motion of the wave, by using a first velocity vector indicating the motion of the wave and a second velocity vector indicating the motion of the object.

### [Supplementary Note 14]

The vehicle detection system according to any one of supplementary notes 10 to 13, further including
a suspicious ship detection means for detecting a suspicious ship by determining whether the vehicle is the suspicious ship when it is determined that the object is the vehicle.

### [Supplementary Note 15]

The vehicle detection system according to supplementary note 14, wherein
the suspicious ship detection means acquires AIS information, compares a position and a motion of the vehicle with a position and a motion of each of ships included in the AIS information, and thereby determines whether the vehicle is the suspicious ship.

### [Supplementary Note 16]

The vehicle detection system according to supplementary note 14, wherein
the suspicious ship detection means determines whether the vehicle is the suspicious ship by comparing a motion of the vehicle with a motion pattern being set in advance.

### [Supplementary Note 17]

The vehicle detection system according to any one of supplementary notes 14 to 16, wherein
presence of the suspicious ship is notified when it is determined that the vehicle is the suspicious ship.

### [Supplementary Note 18]

The vehicle detection system according to any one of supplementary notes 10 to 17, wherein
the laser light is emitted by an emission means provided in water, and
the reflected light is received by a light reception means provided in water.

### [Supplementary Note 19]

A vehicle detection method including:
by a motion detection means, detecting a motion of an object on water and a motion of a wave on a water surface around the object, based on laser light being irradiated onto the object and the water surface, and reflected light associated to the laser light; and,
by a vehicle detection means, detecting a vehicle by determining whether the object is the vehicle, based on the motion of the object and the motion of the wave.

### [Supplementary Note 20]

The vehicle detection method according to supplementary note 19, further including,
by the motion detection means, detecting a motion of the object and a motion of the wave, based on a Doppler shift amount of the reflected light.

### [Supplementary Note 21]

The vehicle detection method according to supplementary note 19, further including,
by the motion detection means, generating a three-dimensional model of the object and the water surface, based on the reflected light, and detecting a motion of the object and a motion of the wave, based on time change of the three-dimensional model.

### [Supplementary Note 22]

The vehicle detection method according to any one of supplementary notes 19 to 20, further including,
by the vehicle detection means, determining whether the object is the vehicle, based on an amount of deviation of a motion of the object with respect to a motion of the wave, by using a first velocity vector indicating the motion of the wave and a second velocity vector indicating the motion of the object.

### [Supplementary Note 23]

The vehicle detecting method according to any one of supplementary notes 19 to 22, further including,
by a suspicious ship detection means, detecting a suspicious ship by determining whether the vehicle is the suspicious ship when determining that the object is the vehicle.

### [Supplementary Note 24]

The vehicle detection method according to supplementary note 23, further including,
by the suspicious ship detection means, acquiring AIS information, comparing a position and a motion of the vehicle with a position and a motion of each of ships included in the AIS information, and thereby determining whether the vehicle is the suspicious ship.

### [Supplementary Note 25]

The vehicle detection method according to supplementary note 23, further including,
by the suspicious ship detection means, determining whether the vehicle is the suspicious ship by comparing a motion of the vehicle with a motion pattern being set in advance.

### [Supplementary Note 26]

The vehicle detection method according to any one of supplementary notes 23 to 25, further including
notifying presence of the suspicious ship when determining that the vehicle is the suspicious ship.

### [Supplementary Note 27]

The vehicle detection method according to any one of supplementary notes 19 to 26, further including:
by an emission means provided in water, emitting the laser light; and,
by a light reception means provided in water, receiving the reflected light.

### [Supplementary Note 28]

A recording medium recording a program for causing a computer to function as:
a motion detection means for detecting a motion of an object on water and a motion of a wave on a water surface around the object, based on laser light being irradiated onto the object and the water surface, and reflected light associated to the laser light; and
a vehicle detection means for detecting a vehicle by determining whether the object is the vehicle, based on the motion of the object and the motion of the wave.

### [Supplementary Note 29]

The recording medium according to supplementary note 28, wherein
the motion detection means detects a motion of the object and a motion of the wave, based on a Doppler shift amount of the reflected light.

### [Supplementary Note 30]

The recording medium according to supplementary note 28, wherein
the motion detection means generates a three-dimensional model of the object and the water surface, based on the reflected light, and detects a motion of the object and a motion of the wave, based on time change of the three-dimensional model.

### [Supplementary Note 31]

The recording medium according to any one of supplementary notes 28 to 30, wherein
the vehicle detection means determines whether the object is the vehicle, based on an amount of deviation of a motion of the object with respect to a motion of the wave, by using a first velocity vector indicating the motion of the wave and a second velocity vector indicating the motion of the object.

### [Supplementary Note 32]

The recording medium according to any one of supplementary notes 28 to 31, the program further causing the computer to function as
a suspicious ship detection means for detecting a suspicious ship by determining whether the vehicle is the suspicious ship when it is determined that the object is the vehicle.

### [Supplementary Note 33]

The recording medium according to supplementary note 32, wherein
the suspicious ship detection means acquires AIS information, compares a position and a motion of the vehicle with a position and a motion of each of ships included in the AIS information, and thereby determines whether the vehicle is the suspicious ship.

### [Supplementary Note 34]

The recording medium according to supplementary note 32, wherein
the suspicious ship detection means determines whether the vehicle is the suspicious ship by comparing a motion of the vehicle with a motion pattern being set in advance.

### [Supplementary Note 35]

The recording medium according to any one of supplementary notes 32 to 34, the program further causing the computer to function as
a notification control unit that executes control for notifying presence of the suspicious ship when it is determined that the vehicle is the suspicious ship.

### REFERENCE SIGNS LIST

1 LIDAR device
2, 2a Watercraft detection device
3 Output device
11 Emission unit
12 Light reception unit
21, 21a Motion detection unit
22 Watercraft detection unit
23 Suspicious ship detection unit
24 Notification control unit
31 Distance calculation unit
32 Three-dimensional model generation unit
33, 33a Velocity vector calculation unit
41 Computer
51 Processor
52 Memory
53 Processing circuit
100, 100a Watercraft detection system

What is claimed is:

1. A vehicle detection device comprising:
at least one memory configured to store instructions; and at least one processor configured to execute the instructions to
detect a motion of an object on water and a motion of a wave on a water surface around the object, based on laser light being irradiated onto the object and the water surface, and reflected light associated to the laser light; and
detect a vehicle by determining whether the object is the vehicle, based on the motion of the object and the motion of the wave.

2. The vehicle detection device according to claim 1, wherein
the at least one processor detects a motion of the object and a motion of the wave, based on a Doppler shift amount of the reflected light.

3. The vehicle detection device according to claim 1, wherein
the at least one processor generates a three-dimensional model of the object and the water surface, based on the reflected light, and detects a motion of the object and a motion of the wave, based on time change of the three-dimensional model.

4. The vehicle detection device according to claim 1, wherein
the at least one processor determines whether the object is the vehicle, based on an amount of deviation of a motion of the object with respect to a motion of the wave, by using a first velocity vector indicating the motion of the wave and a second velocity vector indicating the motion of the object.

5. The vehicle detection device according to claim 1, wherein
the at least one processor detects a suspicious ship by determining whether the vehicle is the suspicious ship when it is determined that the object is the vehicle.

6. The vehicle detection device according to claim 5, wherein
the at least one processor acquires AIS information, compares a position and a motion of the vehicle with a position and a motion of each of ships included in the AIS information, and thereby determines whether the vehicle is the suspicious ship.

7. The vehicle detection device according to claim 5, wherein
the at least one processor determines whether the vehicle is the suspicious ship by comparing a motion of the vehicle with a motion pattern being set in advance.

8. The vehicle detection device according to claim 5, wherein
presence of the suspicious ship is notified when it is determined that the vehicle is the suspicious ship.

9. The vehicle detection device according to claim 1, wherein
the laser light is emitted by emission unit provided in water, and
the reflected light is received by light reception unit provided in water.

10. A vehicle detection system comprising:
at least one memory configured to store instructions; and at least one processor configured to execute the instructions to
detect a motion of an object on water and a motion of a wave on a water surface around the object, based on laser light being irradiated onto the object and the water surface, and reflected light associated to the laser light; and
detect a vehicle by determining whether the object is the vehicle, based on the motion of the object and the motion of the wave.

11. The vehicle detection system according to claim 10, wherein
the at least one processor detects a motion of the object and a motion of the wave, based on a Doppler shift amount of the reflected light.

12. The vehicle detection system according to claim 10, wherein
the at least one processor generates a three-dimensional model of the object and the water surface, based on the reflected light, and detects a motion of the object and a motion of the wave, based on time change of the three-dimensional model.

13. The vehicle detection system according to claim 10, wherein
the at least one processor determines whether the object is the vehicle, based on an amount of deviation of a motion of the object with respect to a motion of the wave, by using a first velocity vector indicating the motion of the wave and a second velocity vector indicating the motion of the object.

14. The vehicle detection system according to claim 10, wherein
the at least one processor detects a suspicious ship by determining whether the vehicle is the suspicious ship when it is determined that the object is the vehicle.

15. The vehicle detection system according to claim 14, wherein
the at least one processor acquires AIS information, compares a position and a motion of the vehicle with a position and a motion of each of ships included in the AIS information, and thereby determines whether the vehicle is the suspicious ship.

16. The vehicle detection system according to claim 14, wherein
the at least one processor determines whether the vehicle is the suspicious ship by comparing a motion of the vehicle with a motion pattern being set in advance.

17. The vehicle detection system according to claim 14, wherein
presence of the suspicious ship is notified when it is determined that the vehicle is the suspicious ship.

18. The vehicle detection system according to claim 10, wherein
the laser light is emitted by emission unit provided in water, and the reflected light is received by light reception unit provided in water.

19. A vehicle detection method comprising:
by at least one memory configured to store instructions; and at least one processor configured to execute the instructions, detecting a motion of an object on water and a motion of a wave on a water surface around the object, based on laser light being irradiated onto the object and the water surface, and reflected light associated to the laser light; and,
by the at least one processor, detecting a vehicle by determining whether the object is the vehicle, based on the motion of the object and the motion of the wave.

20. The vehicle detection method according to claim 19, further comprising,
by the at least one processor, detecting a motion of the object and a motion of the wave, based on a Doppler shift amount of the reflected light.

21-27. (canceled)
